(19) United States
(12) Patent Application Publication
(10) Pub. No.: US 2017/0242532 A1
(43) Pub. Date: Aug. 24, 2017

(54) Information Interacting Method And Device

(71) Applicants: Li Zheng, Dongguan (CN); Smart Electronic Industrial (Dong Guan) Co., Ltd., Dongguan (CN)

(72) Inventor: Li Zheng, Dongguan (CN)

(73) Assignees: Smart Electronic Industrial (Dong Guan) Co., Ltd., Dongguan (CN); Li Zheng, Dongguan (CN)

(21) Appl. No.: 15/439,330

(22) Filed: Feb. 22, 2017

(30) Foreign Application Priority Data
Feb. 23, 2016 (CN) 201610100012.0

(51) Int. Cl. G06F 3/041; G06F 3/0488; H04M 3/22; G06F 3/0346

(52) U.S. Cl. CPC G06F 3/0416; G06F 3/0346; G06F 3/04883; H04M 3/22

(57) ABSTRACT

An information interacting method is provided, which performs the following steps when a mobile device is in a lock or sleep mode: in response to an operation event acted on the mobile device, a background process parsing the operation event into a corresponding expression; initiating a default connection to send a data message corresponding to the expression to a specific target; and displaying perceptible signals on the mobile device after the data message is sent.

### CROSS-REFERENCE TO RELATED APPLICATIONS

The present application claims priority from CN201610100012.0 filed Feb. 23, 2016, which is incorporated herein by reference.

### FIELD OF THE INVENTION

The present invention relates to a technical field of information transmission and more particularly, relates to an information interacting method and a corresponding device.

### BACKGROUND OF THE INVENTION

With development of mobile internet, smart mobile devices become indispensable. Nowadays communication between different users is realized by mobile devices. Smart mobile phones and watches are widely used and become the fastest and most convenient information transmission means due to their portability and convenience. Global mobile communication industry is developed rapidly, and corresponding mobile communication service is also increased. Especially with development of communication techniques, mobile communication techniques of a new generation provide data service of higher speed. In addition to phone calling, more and more users have also communicated with other persons using short message, qq chatting tool and web-chat tool.

Currently, in case a user initiates communication with another person, he should at first unlock a keyboard or screen of his mobile phone. Then he opens a contact interface or third party interface and finds out information of the desired person and finally communicates with the person according to the obtained information. Apparently, this kind of communication is low efficient and inconvenient, in particular when the user encounters dangers and needs helps of outside, thus this kind of complicated communication means resulting in potential security risks.

### BRIEF SUMMARY OF THE INVENTION

One object of an embodiment of the invention is to overcome the above problems and provide an information interacting method and device which lead to a more convenient information interacting means.

To achieve above object, an embodiment of the invention employs the following solution.

An information interacting method is provided, which performs the following steps when a mobile device is in a lock or sleep mode:

in response to an operation event acted on the mobile device, a background process parsing the operation event into a corresponding expression;

initiating a default connection to send a data message corresponding to the expression to a specific target; and

displaying perceptible signals on the mobile device after the data message is sent.

Furthermore, the step of in response to an operation event acted on the mobile device a background process parsing the operation event into a corresponding expression further including:

determining whether the operation event is identical to a predefined operation event and if yes, then the background process parsing the operation event into a corresponding expression.

Specifically, the operation event includes a first and second operation events. The first operation event is for constructing content information of the expression, and the second operation event is for constructing the specific target.

The data message includes the content information corresponding to the first operation event and the specific target information corresponding to the second operation event.

In accordance with an embodiment of the invention, the first and second operation events include a tap detected on a touchscreen during a predefined time period, or a number of taps occurred in a predefined time interval.

In accordance with an embodiment of the invention, the first and second operation events include a slide detected on a touchscreen during a predefined time period, or multiple slides occurred in a predefined time interval.

In accordance with an embodiment of the invention, a same area on the touchscreen is searched to detect the first and second operation events.

In accordance with another embodiment of the invention, different coordinate ranges on the touchscreen are searched to detect the first and second operation events.

In detail, the first and second operation events all mean content information detected by a sensor of the mobile device during a predefined time period and representing a single turning of the device, or content information detected by a sensor of the mobile device and representing multiple turnings of the device in a predefined time interval.

Moreover, the method further includes obtaining a predefined list containing mapping relations between the expressions and operation events, prior to the step of the background process parsing the operation event into a corresponding expression.

Furthermore, the step of obtaining a predefined list containing mapping relations between the expressions and operation events includes: receiving a setting command, and recording a local account of the mobile device and mapping relations between the expressions and operation events for generating and locally storing the predefined list.

Specifically, the predefined list is sent to a remote interface such that the list is further sent to a third party mobile device to which the list is directed.

Preferably, a request command is sent to the remote interface to obtain the predefined list containing mapping relations between the expressions and operation events.

Preferably, the predefined list further includes unique identifier information for distinguishing it from other predefined lists.

Specifically, the mapping relations between the expressions and operation events include a mapping relation between a first operation event information and content information in the expression, and mapping relation between a second operation event information and specific target.

In accordance with an embodiment of the invention, the first and second operation event information both include a predefined time length, times of touches during the time length, and time interval between two adjacent touches.

Specifically, the touches occur in a single coordinate area of the touchscreen, or occur at the same time in several discontinuous coordinate areas of the touchscreen.

In accordance with another embodiment of the invention, the first and second operation event information both include a predefined time length, times of slide detected on the touchscreen during the time length, direction and path of the slide, and time interval between two adjacent slides.

In particular, a same area on the touchscreen is searched to detect slides on the touchscreen, or different areas on the touchscreen are searched to detect synchronous slides on the screen.

Specifically, the first and second operation event information both include a predefined time length, times of turning detected by a sensor of the mobile device during the time length, direction of turning, and time interval between two adjacent turnings.

Preferably, the step of initiating a default connection to send a data message corresponding to the expression to a specific target further includes initiating a default connection with a third party interface to send a data message corresponding to the expression to a specific target.

Preferably, the step of initiating a default connection with a third party interface to send a data message corresponding to the expression to a specific target further includes initiating a remote server interface predefined by a default connection of the background process to send a data message corresponding to the expression to a specific target.

Specifically, after the mobile device receives the data messages, it analyzes the same to obtain content information corresponding to the expression.

Further, the content information is presented with perceptible signals.

Preferably, the step of presenting the content information with perceptible signals includes converting the content information into voice signals and playing back the same.

Preferably, the step of presenting the content information with perceptible signals includes displaying the content information in a visual interface.

One embodiment of the invention relates to an information interacting device for use when a mobile device is in a lock or sleep mode, including:

a parsing module for in response to an operation event occurred on a mobile device parsing the operation event into a corresponding expression with the help of a background process;

a sending module for initiating a default connection to send a data message corresponding to the expression to a specific target; and

a feedback module for displaying perceptible signals on the mobile device after the data message is sent.

Moreover, the parsing module is also used for determining the operation event is identical to a predefined operation event.

If they are identical, the operation event is parsed by the background process into a corresponding expression.

Specifically, the operation event includes a first and second operation events. The first operation event is for constructing content information of the expression, and the second operation event is for constructing the specific target.

The data message includes the content information corresponding to the first operation event and the specific target information corresponding to the second operation event.

In accordance with an embodiment of the invention, the first and second operation events include a tap detected on a touchscreen during a predefined time period, or a number of taps occurred in a predefined time interval.

In accordance with an embodiment of the invention, the first and second operation events include a slide detected on a touchscreen during a predefined time period, or a number of slides occurred in a predefined time interval.

In particular, a same area on the touchscreen is searched to detect slides on the touchscreen, or different areas on the touchscreen are searched to detect synchronous slides on the screen.

Specifically, the first and second operation event information both include content information representing a turning of the mobile device detected by a sensor of the device during a predefined time, or content information representing a number of turnings of the mobile device detected by a sensor of the device in predefined time intervals.

The device further includes an obtaining module for obtaining a predefined list containing a mapping relation between the expression and operation event, before the background process of the parsing module parsing the operation event into a corresponding expression.

Furthermore, the obtaining module is also for receiving a setting command, and recording a local account of the mobile device and mapping relations between the expressions and operation events for generating and locally storing the predefined list.

The device further includes a sending module for sending the predefined list to a remote interface such that the list is further sent to a third party mobile device to which the list is directed.

The obtaining module is also intended to send a request command to the remote interface to obtain the predefined list containing mapping relations between the expressions and operation events.

Preferably, the predefined list further includes unique identifier information for distinguishing it from other predefined lists.

Specifically, the mapping relations between the expressions and operation events include a mapping relation between a first operation event information and content information in the expression, and mapping relation between a second operation event information and specific target.

In accordance with an embodiment of the invention, the first and second operation event information both include a predefined time length, times of touches during the time length, and time interval between two adjacent touches.

In particular, a same area on the touchscreen is searched to detect taps on the touchscreen, or different areas on the touchscreen are searched to detect synchronous taps on the screen.

In accordance with another embodiment of the invention, the first and second operation event information both include a predefined time length, times of slide detected on the touchscreen during the time length, direction and path of the slide, and time interval between two adjacent slides.

In particular, a same area on the touchscreen is searched to detect slides on the touchscreen, or different areas on the touchscreen are searched to detect synchronous slides on the screen.

Specifically, the first and second operation event information both include a predefined time length, times of turning detected by a sensor of the mobile device during the time length, direction of turning, and time interval between two adjacent turnings.

Furthermore, the sending module is also intended for initiating a default connection with a third party interface to send a data message corresponding to the expression to a specific target.

Furthermore, the sending module is also intended for initiating a remote server interface predefined by a default connection of the background process to send a data message corresponding to the expression to a specific target.

The device further includes a receiving module for parsing a data message to obtain content information corresponding to the expression after the mobile device receives said data messages.

The device further includes a displaying module for displaying the content information in perceptible signals.

Optionally, the displaying module is also used for converting the content information into voice signals and playing back the same.

Alternatively, the displaying module is also used for displaying the content information in a visual interface.

Compared to prior art techniques, the various embodiments of the invention bring the following good effects.

At first, according to this information interacting method and device, when a mobile device is in a lock or sleep mode, in response to an operation event acted on the mobile device, a background process parses the operation event into a corresponding expression. Next, a default connection to send a data message corresponding to the expression to a specific target is started. Finally, perceptible signals are displayed on the mobile device after the data message is sent. In other words, even when the mobile device is in a lock or sleep mode, communications with a specific target is still realized by a default connection with operation events acted on the mobile device, thus avoiding unlock of the device before performing any communication through default connection, improving efficiency of communications, and making information interaction more convenient and safe. In addition, user experience is also enhanced by displaying perceptible signals on the mobile device after successful transmission of data.

Secondly, according to this information interacting method and device, a predefined list containing mapping relation between the operation event and expression is set by the user or obtained by sending a request instruction to a server. Moreover, the operation events include a first operation event indicating information content and a second operation event indicating information of a specific target. Accordingly, even when the mobile device is in a lock or sleep mode, it is still able to select the specific target and send corresponding information content to the same by operation events acted on the mobile device, thereby increasing communications efficiency and making information interaction more convenient and safe. This applies even when the user is in danger situation.

Thirdly, according to this information interacting method and device, data message corresponding to the expression may be transmitted to a specific target by initiating a remote server interface defined by a background process default connection or initiating a default connection with a third party interface such as widely used third party communications tools QQ, webchat or MSN. This expands application of the technical solution, and maintains effectiveness of the same solution.

Finally, according to this information interacting method and device, even when the mobile device is in a lock or sleep mode, data message is received and parsed to obtain content information corresponding to the expression and the content information is displayed in perceptible signals. In other words, even when the mobile device is in a lock or sleep mode, it is still possible to receive data message corresponding to the operation event from another party, parse the data message into corresponding content information by the background process, and display the same information in perceptible signals. There is no need to unlock the mobile device to view the content information, and accordingly, it is convenient to read the received information and information interaction efficiency is improved.

### BRIEF DESCRIPTION OF THE DRAWINGS

FIG. 1 shows a flowchart of an embodiment of an information interacting method of the invention;

FIG. 2 shows a flowchart of an embodiment of an information interacting method of the invention;

FIG. 3 shows a flowchart of an embodiment of an information interacting method of the invention;

FIG. 4 shows a structural view of an embodiment of an information interacting device of the invention;

FIG. 5 shows a structural view of an embodiment of an information interacting device of the invention; and

FIG. 6 shows a structural view of an embodiment of an information interacting device of the invention.

### DETAILED DESCRIPTION

Various embodiments of the invention are described below in greater detail. The examples of these embodiments are illustrated in the drawings. Throughout the drawings, same or similar numerals are used to refer to the same or similar elements or those having the same or similar function. The description of the embodiments in conjunction with the drawings is only exemplary for explaining the principle of the invention and is not to be interpreted to limit the invention.

It should be understood by person of the ordinary skill in the art that unless otherwise specified, terms “a”, “one”, “the” and “said” in singular form may also be used in plural form. It should be further understood that the term “include” as used herein means presence of said feature, integer, step, operation, element and/or component, but not excluding presence of one or more additional other feature, integer, step, operation, element and/or component and/or their combination. The term “and/or” includes one or more related elements and all combination thereof.

It should be understood by a person of the ordinary skill in the art that unless otherwise specified, all the terminology (including technical and scientific terms) have their ordinary meaning as understood by person of the art.

It should also be understood by a person of the ordinary skill in the art that the device (or terminal, or terminal device) of the invention may include a device of a wireless signal receiver capable of only receiving signals while not being capable of transmitting signals. It may also include devices capable of receiving and transmitting signals. Examples include cellular devices or other communication devices, cellular devices or other communication devices with single line or multiple-line display(s) or without multiple-line display(s), PCS (Personal Communications Service) with the ability of processing voice, data, fax and/or data communications; PDA (Personal Digital Assistant) including radio frequency receivers, pagers, internet/intranet accessible devices, network browsers, notepads, or calendars, GPS (Global Positioning System) receivers; Laptop and/or palmtop computers, and/or other devices that include a radio frequency receiver. The device may be portable, transportable, or installable into a vehicle (aviation, shipping and/or land), and may be configured to be operated in a given location, and/or a distributed location, or be operated on earth and/or any other location in space. The device may also include a communication terminal, internet access terminal, music/video play terminal such as a PDA and/or mobile phone, or a smart TV, top box and the like.

A person having ordinary skill in the art should know that a remote network device as used herein includes but is not limited to computers, network hosts, a single network server, and a cloud network including multiple network server sets or multiple servers. Here, a cloud network includes many computers or network servers based on cloud computing. Cloud computing is one kind of distributed computation system, and it comprises a super virtual computer including a number of computers that are loosely coupled with one another. In various embodiments of the invention, the remote network device, the terminal device, and the wireless network system (“WNS”) may communicate with each other by any communication means, which may include but is not limited to: mobile communication based on 3GPP, LTE or WIMAX; computer network communication based on a protocol such as TCP/IP or UDP; and near field wireless transmission based on Bluetooth or an infrared transmission standard.

It is necessary to make a brief introduction to application and principles of embodiments of the invention.

In technical field of internet, generally there are user terminals (user mobile terminals), networks and servers (e.g. Web servers of websites). The user terminals may be internet mobile terminals of users such as PCs, laptops, smart devices with webpage browsing function such as PDA, and Mobile Internet Device (MID) and smart phones. In internet environment, these mobile terminals may request some services from another process.

Servers generally are remote computer systems accessible through communication means such as internet. Moreover, servers may supply services to multiple user terminals in the internet. The process of supplying services includes receiving from the user terminal a request, collecting identity information of the terminals and returning information to the terminals. In fact, servers function as information providers in the internet. The servers often reside in a service provider, or are configured by the same provider to supply service. These service providers may be for example websites of internet companies.

The information interacting method and device of some embodiments of the invention may be described in context of mobile devices with communications function such as smart phones. The smart phone may run as a sender or receiver according to the information interacting method and device of some embodiments of the invention. A server side may also be included in which predefined communications protocols for realizing communication between the sender and receiver and predefined list containing mapping relation between expression and operation event may be stored.

Some embodiments of the invention employing forgoing principles will now be described. It is noted that various embodiments are directed to an information interacting method. That is, this method is described from view of mobile devices. The method may be implemented as computer programs to be performed on mobile devices. The devices include but not are limited to smart terminals such as mobile phones and PDAs capable of communicating with other servers or mobile devices via a network. To simplify description of embodiments, a smart phone equipped with an Android system will be taken as an example. This is only exemplary and the scope of the invention is not limited to this. The method and device of embodiments may also be suitable for other kinds of operating systems for example Linux or ios operating systems.

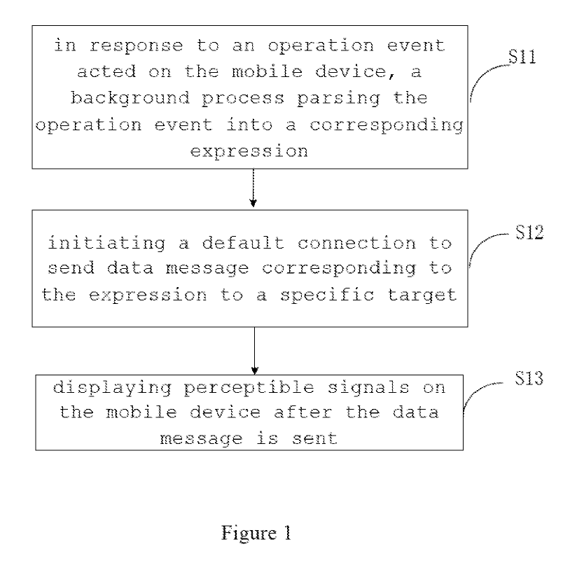

Attention is paid to FIG. 1. In accordance with an embodiment of the invention, an information interacting method includes the following step:

S11, in response to an operation event acted on the mobile device, a background process parsing the operation event into a corresponding expression.

when the mobile device is in a lock or sleep mode, the mobile device detects a specific operation event, and determines whether the operation event is identical to a predefined operation event and if yes, then the background process parses the operation event into a corresponding expression. Otherwise it means that the operation event detected by the device is not valid control instructions, and accordingly, the background process of the mobile device does not perform any operation.

It is noted that the background process as mentioned in this embodiment means a service process registered in system by a program module realized by the method of this embodiment. The background process is able to parse the operation event into a corresponding expression by searching for a predefined list into which mapping relation between the expression and operation event is stored. It is understood that the operation event may be tap, slide acted on a smart phone touchscreen, or turning action of the phone detected by a gravity sensor of the phone. The expression may be a binary data frame or data packet of a certain encoded format.

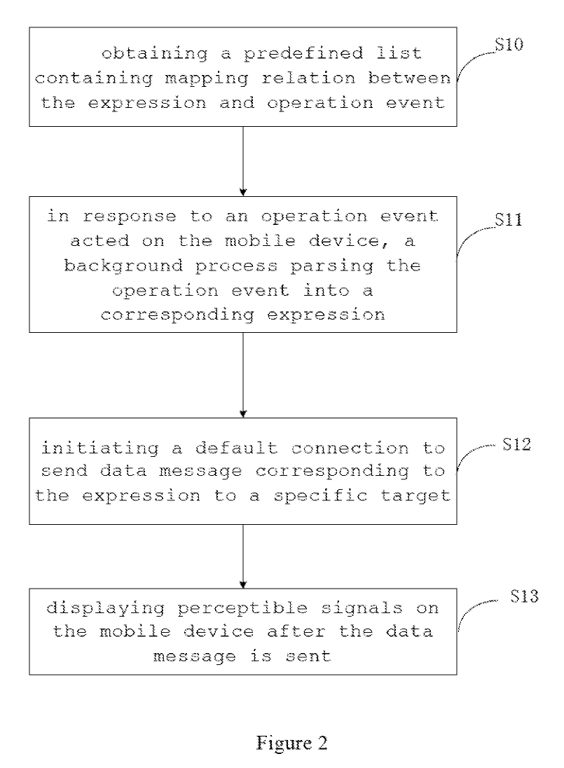

Of course, referring to FIG. 2, it is also understood that prior to the step of parsing the operation event into a corresponding expression by the background process, the following step is included:

S10, obtaining a predefined list containing mapping relation between the expression and operation event.

Specifically, this step of obtaining may be realized in accordance with following embodiments.

In an embodiment of the invention, when the mobile device is locked or in a sleep mode, a predefined list containing mapping relation between the expression and operation event may be defined on the mobile device. It is noted that a setting command may be input into the mobile device at first, and then, a local account of the mobile device and mapping relation between the expression and operation event may be input into the same device to generate a predefined list and store it locally. Here, the mapping relations between the expressions and operation events include a mapping relation between a first operation event information and content information in the expression, and mapping relation between a second operation event information and specific target for easily and directly sending the content information of the expression to a corresponding specific target in a subsequent sending course. The specific target may be a target phone number or target user account of a third part application.

Furthermore, after the predefined list is created and stored in the mobile device, it is further required to send the list to a server side by a remote interface. The server parses the predefined list to obtain specific target information to which the list is directed. After that, the predefined list is forwarded to the specific target which may be a target phone number or a target user account of a third party application.

In another embodiment of the invention, when the mobile device is locked or in a sleep mode, a predefined list containing mapping relation between the expression and operation event is obtained by sending a request command to the server. It is understood that the predefined list may be generated on the server, or transmitted to the same server by a third party mobile device through a remote interface, while the local mobile device should send a request command to the server by a remote interface asking the predefined list, then receives the same list from the server, and stores the list locally.

Furthermore, the predefined list further includes unique identifier information for distinguishing it from other predefined lists at the server side.

In particular, in one embodiment of the invention, the operation event includes a first and second operation events. The first operation event is for constructing content information of the expression, and the second operation event is for constructing the specific target. It is understood that the operation event may be tap, slide acted on a smart phone touchscreen, or turning action of the phone detected by a gravity sensor of the phone. The operation events are explained below.

In one embodiment of the invention, the first and second operation events include a tap detected on a touchscreen during a predefined time period, or a number of taps occurred in a predefined time interval. Specifically, when a mobile device is in a lock or sleep mode, the user may tap the touchscreen of the mobile device at a particular position once or more times during a predefined period to indicate different meanings. For example, tap in A region of the touchscreen may represent selection of a target contact person, i.e., a specific target. Correspondingly, taps in B region of the screen may represent input of content information. In this situation, tap in A region may occur once and corresponding expression is “01”. The contact person corresponding to this expression is “phone number of Zhang, san”. Next, taps in B region of the touchscreen is repeated for three times in a predefined 30 seconds, and a corresponding expression is “1010”. The content information corresponding to this expression may be “I miss you” or “in conference”. Of course, this embodiment is only for illustrative purposes. In other embodiments, other correspondence between operation events and expressions may be presented. It is noted that in forgoing embodiment, the operation events are performed on the touchscreen of the mobile device. Indeed, they may occur on the fixed physical buttons of the device.

It is understood that the B region of the touchscreen for detecting the first operation events may be different from the A region for detecting the second operation events. Alternatively, these two regions may be the same region. For example, assume these two regions are the same region. The first and second operation events may be distinguished from each other by their respective distinct features. In accordance with an embodiment of the invention, the first operation events representing the content information may be taps with a single finger, while the second operation events representing the specific target may be taps with several fingers. Of course, the first and second operation events may be distinguished from each other by different time intervals. It is noted that in forgoing embodiment, the operation events are performed on the touchscreen of the mobile device. Indeed, they may occur on the fixed physical buttons of the device. For example, different buttons may be configured to receive these operation events respectively and accordingly distinguish the first and second operation events.

In accordance with an embodiment of the invention, when setting the predefined list containing a mapping relation between the expressions and operation events, time period of predefined length, and times of taps detected on the touchscreen or buttons during the time period should also be set. Time interval between two adjacent taps should also be set. For instance, interval less than 2 seconds may represent short taps, while interval more than 3 seconds may represent long taps. In addition, these short and long taps may be assigned different meanings, thus greatly enriching kinds of information content and specific target.

In accordance with an embodiment of the invention, when a mobile device is in a lock or sleep mode, it is determined that taps occur with a single finger in case these taps are detected in a single area of the touchscreen or button. Correspondingly, it is determined that taps occur with multiple fingers if synchronous taps are found in multiple areas of the touchscreen or button. It is noted that in forgoing embodiment, the operation events are performed on the touchscreen of the mobile device. Indeed, they may occur on the fixed physical buttons of the device.

In one embodiment of the invention, the first and second operation events include a slide detected on a touchscreen during a predefined time period, or a number of slides occurred in a predefined time interval. Specifically, when a mobile device is in a lock or sleep mode, the user may slide across the touchscreen of the mobile device at a particular position once or more times during a predefined period to indicate different meanings. Alternatively, different meanings may also be defined by a sliding direction across the screen, sliding path and interval between two adjacent slides. For example, slide in A region of the touchscreen may represent selection of a target contact person, i.e., a specific target. Correspondingly, slides in B region of the screen may represent input of content information. The user may slide his finger in the A region of the touchscreen following a path of “L” shape along a certain direction, and the corresponding expression is “010”. The contact person corresponding to this expression is “phone number of Li, si”. Next, the user slides his finger in B region of the touchscreen following a path of “U” shape along a certain direction in a predefined 30 seconds, and a corresponding expression is “1010”. The content information corresponding to this expression may be “already at home” or “in conference”. Of course, this embodiment is only for illustrative purposes. In other embodiments, other correspondence between operation events and expressions may be presented.

It is understood that the B region of the touchscreen for detecting the first operation events may be different from the A region for detecting the second operation events. Alternatively, these two regions may be the same region. For example, assume these two regions are the same region. The first and second operation events may be distinguished from each other by their respective distinct features. In accordance with an embodiment of the invention, the first operation events representing the content information may be slides with a single finger, while the second operation events representing the specific target may be slides with several fingers. Or, the first and second operation events may have different sliding directions. Of course, the first and second operation events may be distinguished from each other by different time intervals.

In accordance with an embodiment of the invention, when setting the predefined list containing a mapping relation between the expressions and operation events, time period of predefined length, and times of slides detected on the touchscreen during the time period, sliding directions, sliding paths, and time interval between two adjacent slides should also be set. For instance, interval less than 2 seconds may represent short slides, while interval more than 3 seconds may represent long slides. In addition, these short and long slides may be assigned different meanings, thus greatly enriching kinds of information content and specific target.

In accordance with an embodiment of the invention, it is determined that slides occur with a single finger in case they are detected in a single area of the touchscreen or button. Correspondingly, it is determined that slides occur with multiple fingers if synchronous slides are found in multiple areas of the touchscreen.

In one embodiment of the invention, the first and second operation events all mean content information detected by a sensor of a mobile device during a predefined time period and representing a single turning of the device, or content information detected by a sensor of the mobile device and representing multiple turnings of the device in a predefined time interval.

It is noted that the mobile device has an acceleration sensor capable of detecting voltage values of the mobile device along X, Y, and Z axes. Acceleration values along these axes may also be calculated following certain calculation rules. In addition, angles between each of these axes and gravity direction may also be determined. As a result, turning direction of the mobile device is also identified. In particular, in one embodiment of the invention, a smart phone equipped with an Android system will be taken as an example. When the mobile device is in a lock or sleep mode, a background process at first gets a SensorManager from the system. Then, the SensorManager is registered through a SensorManager.getDefaultSensor(Sensor.TYPE_ORIENTATION). At the same time, the SensorManager should be monitored by an android.hardware.SensorEventListener interface. For example, a SensorManager.SENSOR_DELAY_NORMAL may be invoked to monitor the acceleration of the acceleration sensor. It should be understood that in fact the essence of various embodiments of the invention has nothing to do with system of the device. The scope of the invention will not be restricted by this embodiment.

There is tolerance when only an acceleration sensor is used for detecting the direction of the movement. To improve detection accuracy of the moving direction of the mobile device, a gyro may be combined with the acceleration sensor to identify the moving direction of the mobile device. For example, when the mobile device is in a lock or sleep mode, the background process may invoke the acceleration sensor to obtain acceleration values along X, Y, and Z axes when the mobile device turns. The gyro may also be invoked to obtain angular acceleration values of the device along these axes. The above values may then be transferred to a MCU of the mobile device for further being processed based on certain algorithm. Finally, the turning direction of the device may be obtained.

In accordance with an embodiment of the invention, the mapping relations between the expressions and operation events include a mapping relation between a first operation event information and content information in the expression, and mapping relation between a second operation event information and specific target. When setting the predefined list containing a mapping relation between the expressions and operation events, the first and second operation event information both include a predefined time length, times of turning detected by a sensor of the mobile device during the time length, direction of turning, and time interval between two adjacent turnings.

In accordance with an embodiment of the invention, the first operation event may include turning left of the mobile device once or for more times during a predefined time period, and a corresponding expression is “1010”. The content information corresponding to this expression may be “already at home” or “in conference”. The second operation event may include turning right of the mobile device once or for more times during a predefined time period, and a corresponding expression is “010”, meaning selection of a target contact person, i.e., a specific target. The contact person corresponding to this expression is “phone number of Li, si”. Of course, this embodiment is only for illustrative purposes. In other embodiments, other correspondence between operation events and expressions may be presented.

It is understood that even when the mobile device is in a lock or sleep mode, selection of a specific target and communications with the same is realized by operation events acted on the mobile device, thus improving communications efficiency, making the information interaction more convenient and safer. Even when the user is in danger situation, the user is still able to utilize his mobile device to send help signals to a specific target based on predefined operation events, without being found by illegal persons.

Attention is further paid to FIG. 1, the method of an embodiment of the invention further includes the step of:

S12, initiating a default connection to send data message corresponding to the expression to a specific target.

It is noted that in previous step S11, when the mobile device is in a lock or sleep mode, the background process of the mobile device has parsed the operation events on the same device into corresponding expressions. In step S12, these expressions should be packaged to form corresponding data messages which then will be sent to the specific target through the default connection. It should be understood that based on predefined communications protocol, the background process may package obtained expressions into data messages in consistent with certain protocol. Said data messages include content information associated with the previously described first operation events and specific target information associated with the previously described second operation events.

In particular, the following embodiments are discussed according to default connection types by which the data messages are transmitted to the target.

In accordance with an embodiment of the invention, when the mobile device is in a lock or sleep mode, data message corresponding to the expression may be transmitted to a specific target by initiating a default connection with a third party interface. The third party interface includes such as third party communications tools QQ, webchat or MSN. When the mobile device is in a lock or sleep mode, the background process sends the data messages to a communications interface open to a third party. A third party communications tool runs to further send the messages to an already registered user of the third party tool. Here, the specific target means user account information of the registered user of the third party tool. The third party interface also includes other third party short message platform interface. At this time, the specific target may be a phone number of the user. Of course, the data messages should also include source account information of the mobile device as a sender. This expands application of the technical solution, and maintains effectiveness of the same solution.

In accordance with an embodiment of the invention, the step of initiating a default connection to send data message corresponding to the expression to a specific target when the mobile device is in a lock or sleep mode further includes initiating a remote server interface predefined by a default connection of the background process to send a data message corresponding to the expression to a specific target. The remote server interface as used herein means it is able to transmit the content information to a specific target. After receiving from the mobile device the data messages, the server obtains the detailed specific target account expression and content information expression by parsing the messages. By searching for mapping relation between the pre-stored specific account expression and target account information, the server sends corresponding content information expression to the target account. Of course, the data messages should also include source account information of the mobile device as a sender.

Attention is further paid to FIG. 1, and the method of an embodiment of the invention further includes the step of:

S13, displaying perceptible signals on the mobile device after the data message is sent.

It should be noted that to improve user experience, when the background process of the mobile device detects that the data messages have been sent to a default connection interface via a network, perceptible signals may be displayed on the mobile device for prompting successful sending of information to the user. The perceptible signals may include for example audio signals or optical signals.

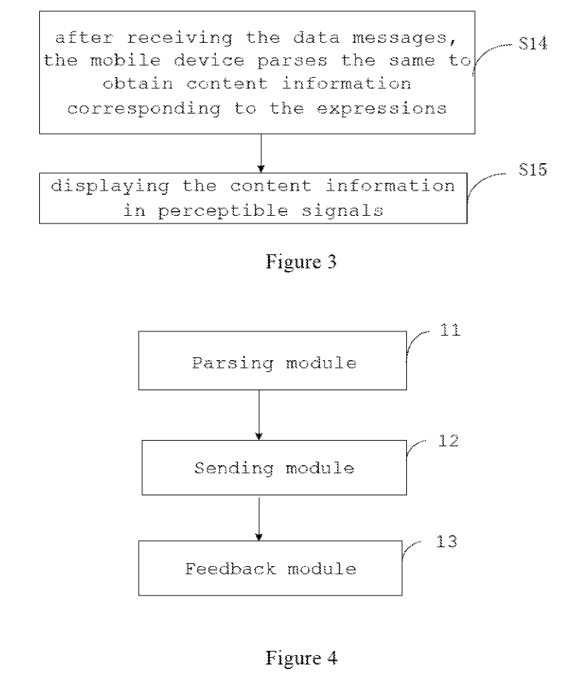

As described above, the mobile device is taken as a sender. Indeed, this device may also function as a receiver of information for receiving data messages from another mobile device. As shown in FIG. 3, the method further includes the following steps:

S14, after receiving the data messages, the mobile device parses the same to obtain content information corresponding to the expressions; and

S15, displaying the content information in perceptible signals.

In particular, after receiving the data messages, the mobile device parses the same to retrieve a local account of a mobile device from which the data messages are sent and expressions representing content information. Next, a predefined list indicating mapping relation between the expressions and content information is searched to find out specific content information associated with the expressions. Finally, the content information is displayed in perceptible signals.

The content information may also be obtained from a server. After receiving the data messages, the server parses the same to retrieve a local account of a mobile device from which the data messages are sent and expressions representing a specific target account information and content information. Next, a predefined list indicating mapping relation between the expressions and content information is searched to find out specific content information and target account information associated with the expressions. Finally, the content information and local account of the mobile device from which the data messages are sent are packaged and sent to the target account. The content information is displayed in perceptible signals on the mobile device functioning as a receiver of the data messages.

Specifically, displaying the content information with perceptible signals includes converting the content information into voice signals and playing back the same or visually displaying the content information.

According to the method of embodiments of the invention, when a mobile device is in a lock or sleep mode, after receiving the data messages corresponding to operation events from another mobile device, the mobile device running as a receiving party drives its background process to parse the data messages into corresponding content information and display the same in perceptible signals, without unlock of the device before viewing the content information. This facilitates reading of the content information and improves information interaction efficiency.

In a summary, various embodiments of the invention provide an information interacting method. According to this method, when a mobile device is in a lock or sleep mode, in response to an operation event acted on the mobile device, a background process parses the operation event into a corresponding expression. Next, a default connection to send a data message corresponding to the expression to a specific target is started. Finally, perceptible signals are displayed on the mobile device after the data message is sent. In other words, even when the mobile device is in a lock or sleep mode, communications with a specific target is still realized by a default connection with operation events acted on the mobile device, thus avoiding unlock of the device before performing any communication through default connection, improving efficiency of communications, and making information interaction more convenient and safe. In addition, user experience is also enhanced by displaying perceptible signals on the mobile device after successful transmission of data.

By the same token, various embodiments of the invention also relate to an information interacting device. Referring to FIG. 4, the information interacting device includes a parsing module 11, a sending module 12 and a feedback module 13. Detailed functions realize by above modules are illustrated below. Here, the monitor terminals may include but not limited to mobile phones, PDAs or desk computers which are able to communication with servers via such as a network.

The parsing module 11 is for in response to an operation event occurred on a mobile device parsing the operation event into a corresponding expression with the help of a background process.

When the mobile device is in a lock or sleep mode, the parsing module 11 of the mobile device detects a specific operation event, and determines whether the operation event is identical to a predefined operation event and if yes, then the background process parses the operation event into a corresponding expression. Otherwise it means that the operation event detected by the device is not valid control instructions, and accordingly, the background process of the mobile device does not perform any operation.

It is noted that the background process of the parsing module 11 as mentioned in this embodiment means a service process registered in system by a program module realized by the method of this embodiment. The background process is able to parse the operation event into a corresponding expression by searching for a predefined list into which mapping relation between the expression and operation event is stored. It is understood that the operation event may be tap, slide acted on a smart phone touchscreen, or turning action of the phone detected by a gravity sensor of the phone. The expression may be a binary data frame or data packet of a certain encoded format.

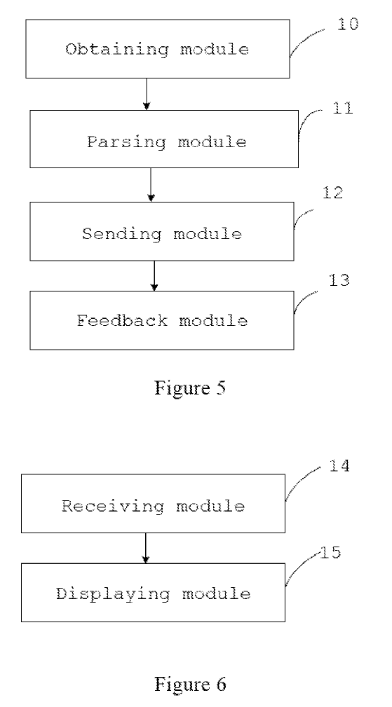

Attention is paid to FIG. 5, and the information interacting device also includes an obtaining module 10 for obtaining a predefined list containing a mapping relation between the expression and operation event, before the background process of the parsing module 11 parsing the operation event into a corresponding expression.

Specifically, the obtaining module 10 may be implemented by the following manners.

In an embodiment of the invention, when the mobile device is locked or in a sleep mode, a predefined list containing mapping relation between the expression and operation event may be defined on the mobile device by the obtaining module 10. The obtaining module 10 may receive a setting command already input into the mobile device, a local account of the mobile device and mapping relation between the expression and operation event already input into the same device to generate a predefined list and store it locally. Here, the mapping relations between the expressions and operation events include a mapping relation between a first operation event information and content information in the expression, and mapping relation between a second operation event information and specific target for easily and directly sending the content information of the expression to a corresponding specific target in a subsequent sending course. The specific target may be a target phone number or target user account of a third part application.

Furthermore, after the predefined list is created and stored in the local mobile device, it is further required to send the list to a server side by a remote interface by the obtaining module 10. The server parses the predefined list to obtain specific target information to which the list is directed. After that, the predefined list is forwarded to the specific target which may be a target phone number or a target user account of a third party application.

In an embodiment of the invention, when the mobile device is locked or in a sleep mode, a predefined list containing mapping relation between the expression and operation event is obtained for the obtaining module 10 by sending a request command to the server. It is understood that the predefined list may be generated on the server, or transmitted to the same server by a third party mobile device through a remote interface, while the local mobile device should send a request command to the server by a remote interface asking the predefined list, then receives the same list from the server, and stores the list locally.

Furthermore, the predefined list further includes unique identifier information for distinguishing it from other predefined lists at the server side.

In particular, in one embodiment of the invention, the operation event includes a first and second operation events. The first operation event is for constructing content information of the expression, and the second operation event is for constructing the specific target. It is understood that the operation event may be tap, slide acted on a smart phone touchscreen, or turning action of the phone detected by a gravity sensor of the phone. The operation events are explained below.

In one embodiment of the invention, the first and second operation events include a tap detected on a touchscreen during a predefined time period, or a number of taps occurred in a predefined time interval. Specifically, when a mobile device is in a lock or sleep mode, the user may tap the touchscreen of the mobile device at a particular position once or more times during a predefined period to indicate different meanings. For example, tap in A region of the touchscreen may be defined by the obtaining module 10 as selection of a target contact person, i.e., a specific target. Correspondingly, taps in B region of the screen may represent input of content information. In this situation, tap in A region may occur once and be parsed by the parsing module 11 into a corresponding expression “01”. The contact person corresponding to this expression is “phone number of Zhang, san”. Next, taps in B region of the touchscreen is repeated for three times in a predefined 30 seconds, and is also parsed by the parsing module 11 into a corresponding expression “1010”. The content information corresponding to this expression may be “I miss you” or “in conference”. Of course, this embodiment is only for illustrative purposes. In other embodiments, other correspondence between operation events and expressions may be presented. It is noted that in forgoing embodiment, the operation events are performed on the touchscreen of the mobile device. Indeed, they may occur on the fixed physical buttons of the device.

It is understood that the B region of the touchscreen for detecting the first operation events may be different from the A region for detecting the second operation events. Alternatively, these two regions may be the same region. For example, assume these two regions are the same region. The first and second operation events may be distinguished from each other by their respective distinct features. In accordance with an embodiment of the invention, the first operation events representing the content information may be taps with a single finger, while the second operation events representing the specific target may be taps with several fingers. Of course, the first and second operation events may be distinguished from each other by different time intervals. It is noted that in forgoing embodiment, the operation events are performed on the touchscreen of the mobile device. Indeed, they may occur on the fixed physical buttons of the device. For example, different buttons may be configured to receive these operation events respectively and accordingly distinguish the first and second operation events.

In accordance with an embodiment of the invention, when setting the predefined list containing a mapping relation between the expressions and operation events, time period of predefined length, and times of taps detected on the touchscreen or buttons during the time period should also be set. Time interval between two adjacent taps should also be set. For instance, interval less than 2 seconds may represent short taps, while interval more than 3 seconds may represent long taps. In addition, these short and long taps may be assigned different meanings, thus greatly enriching kinds of information content and specific target.

In accordance with an embodiment of the invention, when a mobile device is in a lock or sleep mode, it is determined that taps occur with a single finger in case these taps are detected in a single area of the touchscreen or button. Correspondingly, it is determined that taps occur with multiple fingers if synchronous taps are found in multiple areas of the touchscreen or button. It is noted that in forgoing embodiment, the operation events are performed on the touchscreen of the mobile device. Indeed, they may occur on the fixed physical buttons of the device.

In one embodiment of the invention, the first and second operation events include a slide detected on a touchscreen during a predefined time period, or a number of slides occurred in a predefined time interval. Specifically, when a mobile device is in a lock or sleep mode, the user may slide across the touchscreen of the mobile device at a particular position once or more times during a predefined period to indicate different meanings. Alternatively, different meanings may also be defined by a sliding direction across the screen, sliding path and interval between two adjacent slides. For example, slide in A region of the touchscreen may represent selection of a target contact person, i.e., a specific target. Correspondingly, slides in B region of the screen may represent input of content information. The user may slide his finger in the A region of the touchscreen following a path of “L” shape along a certain direction, and the corresponding expression is “010”. The contact person corresponding to this expression is “phone number of Li, si”. Next, the user slides his finger in B region of the touchscreen following a path of “U” shape along a certain direction in a predefined 30 seconds, and a corresponding expression is “1010”. The content information corresponding to this expression may be “already at home” or “in conference”. Of course, this embodiment is only for illustrative purposes. In other embodiments, other correspondence between operation events and expressions may be presented.

It is understood that the B region of the touchscreen for detecting the first operation events may be different from the A region for detecting the second operation events. Alternatively, these two regions may be the same region. For example, assume these two regions are the same region. The first and second operation events may be distinguished from each other by their respective distinct features. In accordance with an embodiment of the invention, the first operation events representing the content information may be slides with a single finger, while the second operation events representing the specific target may be slides with several fingers. Or, the first and second operation events may have different sliding directions. Of course, the first and second operation events may be distinguished from each other by different time intervals.

In accordance with an embodiment of the invention, when setting the predefined list containing a mapping relation between the expressions and operation events, time period of predefined length, and times of slides detected on the touchscreen during the time period, sliding directions, sliding paths, and time interval between two adjacent slides should also be set. For instance, interval less than 2 seconds may represent short slides, while interval more than 3 seconds may represent long slides. In addition, these short and long slides may be assigned different meanings, thus greatly enriching kinds of information content and specific target.

In accordance with an embodiment of the invention, it is determined that slides occur with a single finger in case they are detected in a single area of the touchscreen or button. Correspondingly, it is determined that slides occur with multiple fingers if synchronous slides are found in multiple areas of the touchscreen.

In one embodiment of the invention, the first and second operation events all mean content information detected by a sensor of a mobile device during a predefined time period and representing a single turning of the device, or content information detected by a sensor of the mobile device and representing multiple turnings of the device in a predefined time interval.

It is noted that the mobile device has an acceleration sensor capable of detecting voltage values of the mobile device along X, Y, and Z axes. Acceleration values along these axes may also be calculated following certain calculation rules. In addition, angles between each of these axes and gravity direction may also be determined. As a result, turning direction of the mobile device is also identified. In particular, in one embodiment of the invention, a smart phone equipped with an Android system will be taken as an example. When the mobile device is in a lock or sleep mode, a background process at first gets a SensorManager from the system. Then, the SensorManager is registered through a SensorManager.getDefaultSensor(Sensor.TYPE_ORIENTATION). At the same time, the SensorManager should be monitored by an android.hardware.SensorEventListener interface. For example, a SensorManager.SENSOR_DELAY_NORMAL may be invoked to monitor the acceleration of the acceleration sensor. It should be understood that in fact the essence of various embodiments of the invention has nothing to do with system of the device. The scope of the invention will not be restricted by this embodiment.

There is tolerance when only an acceleration sensor is used for detecting the direction of the movement. To improve detection accuracy of the moving direction of the mobile device, a gyro may be combined with the acceleration sensor to identify the moving direction of the mobile device. For example, when the mobile device is in a lock or sleep mode, the background process may invoke the acceleration sensor to obtain acceleration values along X, Y, and Z axes when the mobile device turns. The gyro may also be invoked to obtain angular acceleration values of the device along these axes. The above values may then be transferred to a MCU of the mobile device for further being processed based on certain algorithm. Finally, the turning direction of the device may be obtained.

In accordance with an embodiment of the invention, the mapping relations between the expressions and operation events include a mapping relation between a first operation event information and content information in the expression, and mapping relation between a second operation event information and specific target. When setting the predefined list containing a mapping relation between the expressions and operation events, the first and second operation event information both include a predefined time length, times of turning detected by a sensor of the mobile device during the time length, direction of turning, and time interval between two adjacent turnings.

In accordance with an embodiment of the invention, the first operation event may include turning left of the mobile device once or for more times during a predefined time period, and a corresponding expression is parsed by the parsing module 11 into “1010”. The content information corresponding to this expression may be “already at home” or “in conference”. The second operation event may include turning right of the mobile device once or for more times during a predefined time period, and a corresponding expression is parsed by the parsing module 11 into “010”, meaning selection of a target contact person, i.e., a specific target. The contact person corresponding to this expression is “phone number of Li, si”. Of course, this embodiment is only for illustrative purposes. In other embodiments, other correspondence between operation events and expressions may be presented.

It is understood that even when the mobile device is in a lock or sleep mode, selection of a specific target and communications with the same is realized by operation events acted on the mobile device, thus improving communications efficiency, making the information interaction more convenient and safer. Even when the user is in danger situation, the user is still able to utilize his mobile device to send help signals to a specific target based on predefined operation events, without being found by illegal persons.

Preferably, the sending module 12 is intended for initiating a default connection to send a data message corresponding to the expression to a specific target.

It is understood that even when the mobile device is in a lock or sleep mode, in the previously described parsing module 11, the operation event has already been parsed by the background process into a corresponding expression. In the sending module 12, the expression should be packaged to form corresponding data messages which then will be sent to the specific target through the default connection. It should be understood that based on predefined communications protocol, the background process may package obtained expressions into data messages in consistent with certain protocol. Said data messages include content information associated with the previously described first operation events and specific target information associated with the previously described second operation events.

In particular, the following embodiments are discussed according to default connection types by which the data messages are transmitted to the target by the sending module 12.

In accordance with an embodiment of the invention, when the mobile device is in a lock or sleep mode, data message corresponding to the expression may be transmitted to a specific target by the sending module 12 initiating a default connection with a third party interface. The third party interface includes such as third party communications tools QQ, webchat or MSN. When the mobile device is in a lock or sleep mode, the sending module 12 sends the data messages to a communications interface open to a third party. A third party communications tool runs to further send the messages to an already registered user of the third party tool. Here, the specific target means user account information of the registered user of the third party tool. The third party interface also includes other third party short message platform interface. At this time, the specific target may be a phone number of the user. Of course, the data messages should also include source account information of the mobile device as a sender. This expands application of the technical solution, and maintains effectiveness of the same solution.

In accordance with an embodiment of the invention, initiating a default connection to send data message corresponding to the expression to a specific target by the sending module 12 when the mobile device is in a lock or sleep mode further includes initiating a remote server interface predefined by a default connection of the background process to send a data message corresponding to the expression to a specific target. The remote server interface as used herein means it is able to transmit the content information to a specific target. After receiving from the mobile device the data messages, the server obtains the detailed specific target account expression and content information expression by parsing the messages with the parsing module 11. By the sending module 12 searching for mapping relation between the pre-stored specific account expression and target account information, the server sends corresponding content information expression to the target account. Of course, the data messages should also include source account information of the mobile device as a sender.

The feedback module 13 is for displaying perceptible signals on the mobile device after the data message is sent.

It should be noted that to improve user experience, when the background process of the mobile device detects that the data messages have been sent to a default connection interface via a network, perceptible signals may be displayed on the mobile device by the feedback module 13 for prompting successful sending of information to the user. The perceptible signals may include for example audio signals or optical signals.

As described above, the mobile device is taken as a sender. Indeed, this device may also function as a receiver of information for receiving data messages from another mobile device. As shown in FIG. 6, a receiving module 14 and a displaying module 15 are also included.

The receiving module 14 is for parsing a data message to obtain content information corresponding to the expression after the mobile device receives said data messages.

The displaying module 15 is intended for displaying the content information in perceptible signals.

In particular, after receiving the data messages by the receiving module 14, the mobile device parses the same to retrieve a local account of a mobile device from which the data messages are sent and expressions representing content information. Next, a predefined list indicating mapping relation between the expressions and content information is searched to find out specific content information associated with the expressions. Finally, the content information is displayed by the displaying module 15 in perceptible signals.

The content information may also be obtained from a server. After receiving the data messages, the server parses the same to retrieve a local account of a mobile device from which the data messages are sent and expressions representing a specific target account information and content information. Next, a predefined list indicating mapping relation between the expressions and content information is searched to find out specific content information and target account information associated with the expressions. Finally, the content information and local account of the mobile device from which the data messages are sent are packaged and sent to the target account. The data messages are received by the receiving module 14 and then are displayed in perceptible signals.

Specifically, displaying by the displaying module 15 the content information with perceptible signals includes converting the content information into voice signals and playing back the same or visually displaying the content information.

According to the information interacting device of embodiments of the invention, when a mobile device is in a lock or sleep mode, after the receiving module 14 receiving the data messages corresponding to operation events from another mobile device, the mobile device running as a receiving party drives its background process to parse the data messages into corresponding content information and display the same in perceptible signals, without unlock of the device before viewing the content information. This facilitates reading of the content information and improves information interaction efficiency.

In a summary, various embodiments of the invention provide an information interacting device. According to this device, when a mobile device is in a lock or sleep mode, in response to an operation event acted on the mobile device, a background process parses the operation event into a corresponding expression. Next, a default connection to send a data message corresponding to the expression to a specific target is started by the sending module 12. Finally, perceptible signals are displayed by the feedback module 13 on the mobile device after the data message is sent. In other words, even when the mobile device is in a lock or sleep mode, communications with a specific target is still realized by a default connection with operation events acted on the mobile device, thus avoiding unlock of the device before performing any communication through default connection, improving efficiency of communications, and making information interaction more convenient and safe. In addition, user experience is also enhanced by displaying perceptible signals on the mobile device after successful transmission of data.

Though various embodiments of the invention have been illustrated above, a person of ordinary skill in the art will understand that, variations and improvements made upon the illustrative embodiments fall within the scope of the invention, and the scope of the invention is only limited by the accompanying claims and their equivalents.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An information interacting method comprising the following steps when a mobile device is in a lock or sleep mode:
in response to an operation event acted on the mobile device, a background process parsing the operation event into a corresponding expression;
initiating a default connection to send a data message corresponding to the expression to a specific target; and
displaying perceptible signals on the mobile device after the data message is sent.

2. The method of claim 1, wherein the step of in response to an operation event acted on the mobile device, a background process parsing the operation event into a corresponding expression further comprising the step of:
determining whether the operation event is identical to a predefined operation event and if yes, then the background process parsing the operation event into a corresponding expression.

3. The method of claim 1, wherein the operation event includes a first and second operation events; the first operation event is for constructing content information of the expression, and the second operation event is for constructing the specific target; and the data message includes the content information corresponding to the first operation event and the specific target information corresponding to the second operation event.

4. The method of claim 3, wherein the first and second operation events include a tap detected on a touchscreen during a predefined time period, or a number of taps occurred in a predefined time interval.

5. The method of claim 3, wherein the first and second operation events include a slide detected on a touchscreen during a predefined time period, or multiple slides occurred in a predefined time interval.

6. The method of claim 4, wherein a same area on the touchscreen is searched to detect the first and second operation events.

7. The method of claim 5, wherein a same area on the touchscreen is searched to detect the first and second operation events.

8. The method of claim 4, wherein different coordinate ranges on the touchscreen are searched to detect the first and second operation events.

9. The method of claim 5, wherein different coordinate ranges on the touchscreen are searched to detect the first and second operation events.

10. The method of claim 3, wherein the first and second operation events all mean content information detected by a sensor of the mobile device during a predefined time period and representing a single turning of the device, or content information detected by a sensor of the mobile device and representing multiple turnings of the device in a predefined time interval.

11. The method of claim 1, wherein further comprising obtaining a predefined list containing mapping relations between the expressions and operation events, prior to the step of the background process parsing the operation event into a corresponding expression.

12. An information interacting device for use when a mobile device is in a lock or sleep mode, comprising:
a parsing module for in response to an operation event occurred on a mobile device parsing the operation event into a corresponding expression with the help of a background process;
a sending module for initiating a default connection to send a data message corresponding to the expression to a specific target; and
a feedback module for displaying perceptible signals on the mobile device after the data message is sent.
